(19) United States
(12) Patent Application Publication
(10) Pub. No.: US 2005/0045000 A1
(43) Pub. Date: Mar. 3, 2005

(54) Hand operated articulating tools for a flush mounted fire hydrant

(76) Inventor: Joseph Sessa, Newport Beach, CA (US)

Correspondence Address: MORLAND C FISCHER, 2030 MAIN ST, SUITE 1050, IRVINE, CA, 92614, US

(21) Appl. No.: 10/651,195

(22) Filed: Aug. 29, 2003

(51) Int. Cl. B25B 13/56; B25B 13/48

(52) U.S. Cl. 81/176.1

(57) ABSTRACT

A set of customized hand operated articulating tools having particular application to enable firefighters to quickly and easily manipulate the operating nut and cover nuts that are typically associated with a flush mounted fire hydrant of the kind that is used to fight airport and aircraft fires. One end of each of the articulating tools is sized to receive and capture the operating and cover nuts of the flush mounted fire hydrant. The opposite end of each articulating tool is adapted to be rotated upwardly relative to the first end to a position above the flush mounted fire hydrant at which to receive a manually applied torque so as to generate a corresponding rotational force and thereby rotate the operating and/or cover nuts.

### BACKGROUND OF THE INVENTION

1. Field of the Invention

This invention relates to a set of customized hand operated articulating tools having particular application for manipulating the operating nut and cover nuts that are associated with a flush mounted fire hydrant such as that found at an airport so that firefighters will be able to fight an airport and/or aircraft fire.

2. Background Art

Fires are known to occur at airports and on aircraft which place both lives and property at great risk. In order to provide a readily available source of water to combat such airport fires while reducing the response time of firefighters, it is desirable to locate fire hydrants near the active runways. It is preferable that these fire hydrants be placed at out of the way locations so as not to disrupt the normal operation of the airport or impede the movement of the vehicles necessary to service the airport. Accordingly, flush mounted fire hydrants are known which are hidden below the surface of a runway or a roadway. By way of example, one flush mounted fire hydrant that is suitable for airport use is manufactured by Mueller.

In this same regard, subsurface enclosures are necessary to house the flush mounted fire hydrants so as to isolate the fire hydrant from dirt and debris and enable rapid access to the fire hydrant during an emergency situation. A pit assembly and cover for enclosing a flush mounted fire hydrant is available from Dabico, Inc. of Costa Mesa, Calif.

However, the tools that are currently available for operating a flush mounted fire hydrant are typically large, rigid, cumbersome and hard to manipulate in an emergency situation. In particular, it is difficult to be able to generate a sufficient rotational force with the conventional tools for quickly and easily operating the flush mounted fire hydrant. Moreover, because of their large size, the conventional tools may become separated from the fire hydrant and misplaced at times when they are needed the most.

Therefore, what is needed is a set of customized hand tool that are compact, easy to use and adapted to generate a sufficient force to enable firefighters to quickly and reliably manipulate a flush mounted fire hydrant so that fire hoses can be connected and water rapidly supplied, whereby time will not be wasted in fighting an airport and/or aircraft fire.

### SUMMARY OF THE INVENTION

In general terms, a flush mounted fire hydrant and customized hand operated articulating tools for controlling the fire hydrant are disclosed. The flush mounted fire hydrant is enclosed by a concrete vault that is located below the surface and near the runway of an airport. The vault includes a pair of steel, spring loaded doors that are closed over top of the flush mounted fire hydrant so as to avoid interfering with the normal operation of the airport. The flush mounted fire hydrant includes, for example, a single 4 inch outlet and a pair of 2½ inch outlets. The outlets are opened for their connection to respective fire hoses by means of rotating respective cover nuts. The flush mounted fire hydrant also includes a main control valve to simultaneously pressurize the outlets. The main control valve is opened by means of rotating an operating nut.

A first hand operated articulating tool for rotating the operating nut of the main control valve of the flush mounted fire hydrant includes a shaft having a handle at one end thereof and a U-shaped yoke at the opposite end. A hex fitting is pivotally connected to the U-shaped yoke so that the shaft can be rotated between a flat, horizontal position and an upright, vertical position. The hex fitting is sized to surround and capture the operating nut of the main control valve. A pair of set screws extend through the hex fitting and into locking engagement with the operating nut of the main control valve to prevent a separation of the first articulating tool from the main control valve. In operation, with the shaft rotated relative to the hex fitting to the upright, vertical position, the first articulating tool functions as a wrench, whereby a torque that is manually applied to the handle causes a corresponding rotational force to be generated at the hex fitting for rotating the operating nut.

A second hand operated articulating tool for rotating the operating nut of the main control valve or the cover nuts of the outlets of the flush mounted fire hydrant includes a J-shaped breaker bar having a hook-like bend at one end thereof and a U-shaped yoke at the opposite end. A recess is formed in the hook-like bend of the breaker bar, and a hose flat is welded to the breaker bar just below the bend. In operation, the second articulating tool functions as a spanner wrench by which the cylindrical coupling of a fire hose is laid on the hose flat, and an outwardly projecting ear of the hose coupling is captured by the recess in the hook-like bend. A rotational force is then applied to the ear of the coupling by the hook-like bend of the second tool for causing the coupling of the fire hose to move into and out of engagement with one of the outlets of the flush mounted fire hydrant.

A socket plate having a hexagonal opening formed therein is pivotally connected to the U-shaped yoke of the second articulating tool so that the breaker bar can be rotated between a flat, horizontal position and an upright, vertical position. The hexagonal opening in the socket plate is sized to surround and capture the operating nut of the main control valve. In operation, with the breaker bar rotated relative to the socket plate to the upright, vertical position, the second articulating tool now functions as a back-up wrench to be laid over the first articulating tool and used in the event that the first tool fails. In this case, a torque that is manually applied to the hook-like bend of the second articulating tool causes a corresponding rotational force to be generated at the socket plate for rotating the operating nut.

A third hand operated articulating tool for rotating the operating nut of the main control valve or the cover nuts of the outlets of the flush mounted fire hydrant includes an elongated bar-like body having a handle pivotally connected to one end thereof and a socket head at the opposite end. The socket head has a hexagonal opening formed therein which is sized to surround and capture the operating nut of the main control valve. In operation, the handle of the third articulating tool is rotated from a vertical position to a horizontal position so as to lie in perpendicular alignment with the bar-like body at which to receive a manually applied torque. The third articulating tool functions as another back-up wrench to be laid over the first articulating tool and used to rotate the operating nut of the main control valve should the first tool fail.

### BRIEF DESCRIPTION OF THE DRAWINGS

FIG. 1 shows a vault within which a flush mounted fire hydrant is enclosed in a closed configuration;

FIG. 2 shows the vault of FIG. 1 in an open configuration with the flush mounted fire hydrant covered by a lid;

FIG. 3 shows the vault in the open configuration of FIG. 2 with the lid removed from the flush mounted fire hydrant;

FIG. 4 shows a first hand operated articulating tool of this invention coupled to the flush mounted fire hydrant and laying in a flat, horizontal at rest position;

FIG. 5 shows the first hand operated articulating tool rotated to an upright, vertical position so as to be ready for use;

FIG. 6 shows a second hand operated articulating tool of this invention coupled to the flush mounted fire hydrant and rotated to an upright, vertical position so as to be ready for use;

FIG. 7 shows a spanner wrench detail at one end of the second articulating tool of FIG. 6;

FIG. 8 shows a third hand operated articulating tool of this invention coupled to the flush mounted fire hydrant with a handle thereof rotated to a horizontal position so as to be ready for use;

FIG. 9 shows a front view of the first hand operated articulating tool lying in the flat, horizontal at rest position;

FIG. 10 shows a front view of the second hand operated articulating tool lying in a flat, horizontal at rest position;

FIG. 11 shows a front view of the third hand operated articulating tool with the handle thereof rotated to the horizontal, ready to use position; and

FIG. 12 is an end view of the third hand operated articulating tool taken along lines 12-12 of FIG. 11.

### DETAILED DESCRIPTION

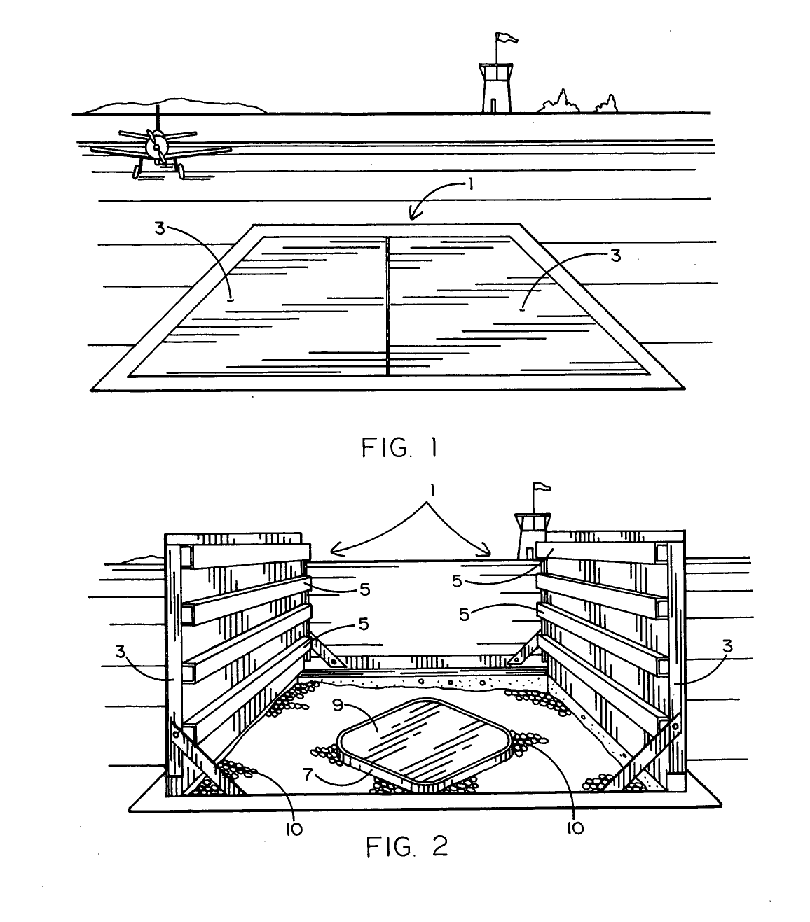

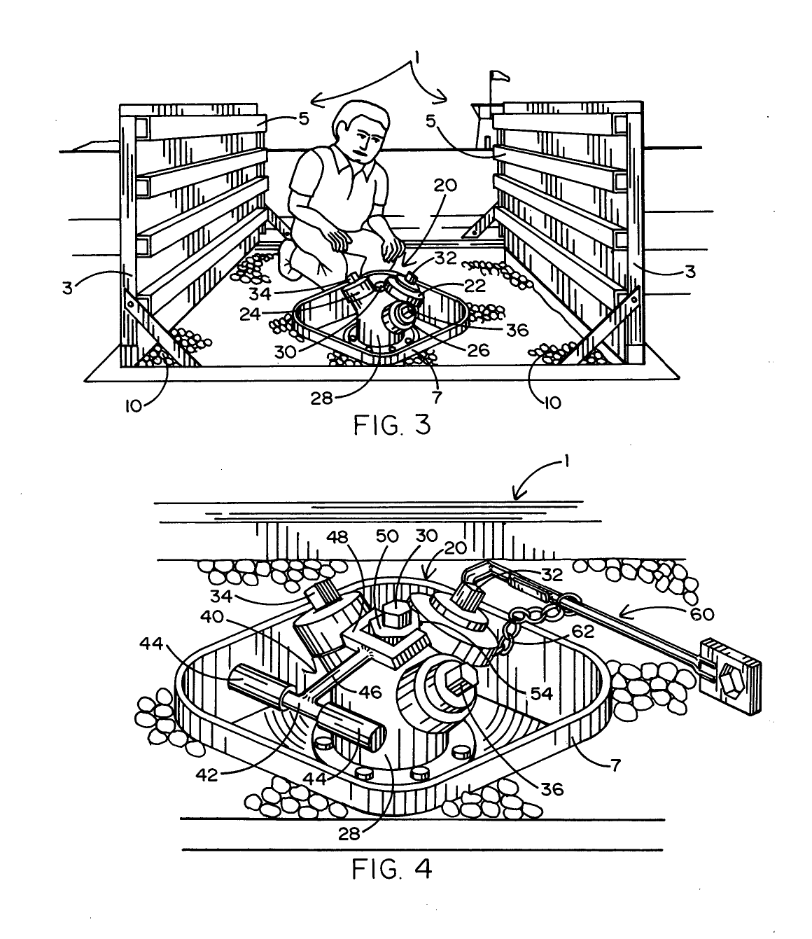

Referring initially to FIGS. 1 and 2 of the drawings, there is shown a concrete vault 1 in a closed configuration (FIG. 1) and in an open configuration (FIG. 2) within which a flush mounted fire hydrant is housed. A vault 1 such as that shown in FIGS. 1 and 2 is desirable for installation on or near a runaway at an airport so that firefighters will have ready access to a fire hydrant (best shown in FIGS. 3-8) should there be a need to battle a fire during an emergency situation. It is further desirable that the vault 1 (in the closed configuration of FIG. 1) and the fire hydrant housed therewithin be unobtrusively located so as to lie generally flush with the roadway/runway so as not to interfere with the normal operation of aircraft and service vehicles that are common to an airport.

The concrete vault 1 includes a pair of hinged doors 3 that are preferably manufactured from steel. For added strength, each of the vault doors 3 is provided with a series of corrugations 5. In the closed configuration of FIG. 1, the doors 3 of vault 1 lie side-by-side one another to cover the flush mounted fire hydrant. In the open configuration of FIG. 2, the doors 3 are lifted (i.e., rotated) upwardly and in opposite directions so as to extend in spaced, parallel alignment with one another and thereby permit access to the flush mounted fire hydrant lying therebelow. The doors 3 may be spring loaded so as to be biased to automatically return to the closed configuration of FIG. 1 in the event that the doors 3 are not completely lifted to the open configuration of FIG. 2.

The flush mounted fire hydrant which lies below the doors 3 of vault 1 is surrounded by a vault housing 7. A removable lid 9 covers the vault housing 7 below doors 3. The work area surrounding the housing 7 within vault 1 is preferably filled with gravel or other small rocks 10 to provide a reliable footing and drainage of residual water that might accumulate during use of the fire hydrant.

A set of customized hand operated articulating tools 40, 60 and 90 is now disclosed to enable firefighters to operate the flush mounted fire hydrant once the doors 3 of vault 1 are lifted to the open configuration of FIG. 2 and the lid 9 is removed from the vault housing 7. As will soon be described, the hand tools are adapted to provide a quick and relatively efficient operation of the flush mounted fire hydrant while replacing the short, rigid and hard to turn conventional hand tools. As will soon be explained, some of the hand tools (e.g., 40 and 60) are sized to be conveniently stored within the vault housing 7 so as to remain readily available for use and lie within easy reach of firefighters should there be an emergency situation at the airport.

Turning to FIG. 3 of the drawings, the flush mounted fire hydrant 20 is shown being surrounded by the housing 7 within the concrete vault 1 below the doors 3. A flush mounted fire hydrant such as that shown in FIG. 3 is generally known and, therefore, only a brief description thereof will be provided. The flush mounted fire hydrant 20 of FIG. 3 includes three water outlets. A 4 inch outlet 22 is sized so as to be capable of feeding water to a typical pumper truck. A pair of 2½ inch outlets 24 and 26 are also provided to be attached to respective hand held hoses so that water can be applied directly to a fire. A main control valve body 28 is provided having a hexagonal operating nut 30. By rotating the operating nut 30 of main control valve body 28, all three of the outlets 22, 24 and 26 will be simultaneously pressurized. Each of the outlets 22, 24 and 26 has a removable cover and an associated hexagonal cover nut 32, 34 and 36. By applying a rotational force to the hexagonal cover nuts 32, 34 and 36, the covers can be removed from outlets 22, 24 and 26 to enable suitable fire hoses to be coupled thereto.

A first hand operated articulating tool 40 having a relatively short length of about 25 cm and being capable of generating a torque that is sufficient to rotate the hexagonal operating nut 30 of the main control valve body 28 is now disclosed while referring concurrently to FIGS. 4, 5 and 9 of the drawings. The first articulating tool 40 includes a handle 42 having grips 44 at opposite ends thereof at which a firefighter can place his hands. One end of a shaft 46 is connected to the handle 42, and the opposite end of shaft 46 is connected to a U-shaped yoke 48. A hex fitting 50 is pivotally coupled to the U-shaped yoke 48 by means of a pair of swivel pins 52, whereby the shaft 46 and the yoke 48 are adapted to rotate relative to hex fitting 50 through an arc of 90 degrees. One or more (e.g., two) set screws 54 extend through sides of hex fitting 50 to enable the articulating tool 40 to be fixedly attached to the operating nut 30 of main control valve body 28 and thereby prevent tool 40 from becoming separated from the main control valve body 28.

The articulating hand operated tool 40 functions as a wrench to rotate the operating nut 30 of main control valve body 28 and thereby cause the outlets 22, 24 and 26 of fire hydrant 20 to be pressurized. In operation, the articulating tool 40 is initially laid flat when at rest and disposed horizontally within the vault housing 7 with the hex fitting 50 thereof held in surrounding engagement with operating nut 30 (best shown in FIG. 4). The shaft 46 of articulating tool 40 is rotated relative to the hex fitting 50 to the upright, vertical position (best shown in FIG. 5) such that the shaft 46 is now in perpendicular alignment with the hex fitting 50. The pivotal connection of the yoke 48 to hex fitting 50 by means of swivel pins 52 facilitates the rotation of the shaft 46 to the vertical position of FIG. 5. Accordingly, a torque that is manually applied to the handle 42 of articulating tool 40 in the vertical, upright position is transmitted as a corresponding rotational force to the operating nut 30 of the main control valve body 28 by way of the U-shaped yoke 48 and the hex fitting 50 coupled thereto.

When it is not in use, the first hand operated articulating tool 40 is stored in the flat, horizontal position within the vault housing 7 with the hex fitting 50 thereof locked in surrounding engagement with the operating nut 30 of the main control valve body 28 in the manner shown in FIG. 4. In this case, the set screws 54 are moved inwardly through the sides of hex fitting 50 and tightened against the operating nut 30. The set screws 54 enable the tool 40 to stay attached to the operating nut 30 within vault housing 7 so as to remain ready for use by preventing a separation of tool 40 before and during an emergency situation.

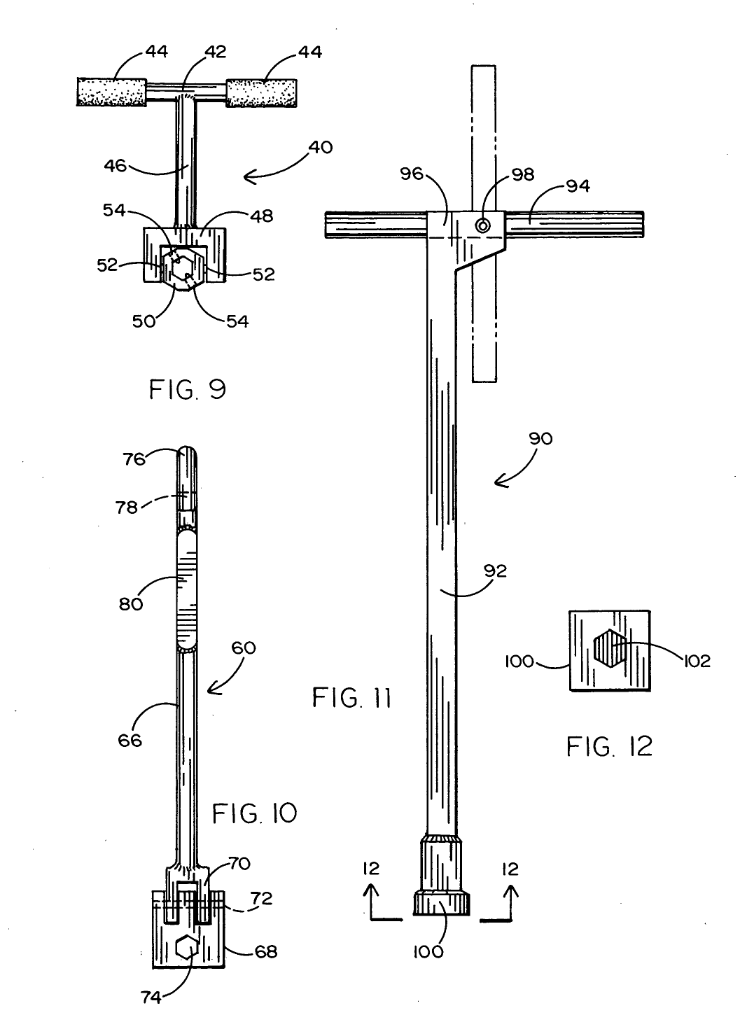

A second hand operated articulating tool 60 by which to generate a torque to rotate the hexagonal operating nut 30 of the main control valve body 28 and the cover nuts 32, 34 and 36 of the outlets 22, 24 and 26 of fire hydrant 20 is disclosed while referring concurrently to FIGS. 5-7 and 10 of the drawings. Like the previously described first articulating hand tool 40 of FIG. 9, it may be desirable for the second articulating tool 60 to be retained within the vault housing 7 during non-emergency situations. To this end, a chain 62 extends between the articulating tool 60 and a stake 64 that is affixed to the interior of vault housing 7 so that tool 60 will be in easy reach of a firefighter and remain continuously available for use while avoiding a possible misplacement thereof at a time of need. Thus, like the previously described first articulating tool 40, the second articulating tool 60 has a size (e.g., about 45 cm) so as to be conveniently stored within the confines of vault housing 7.

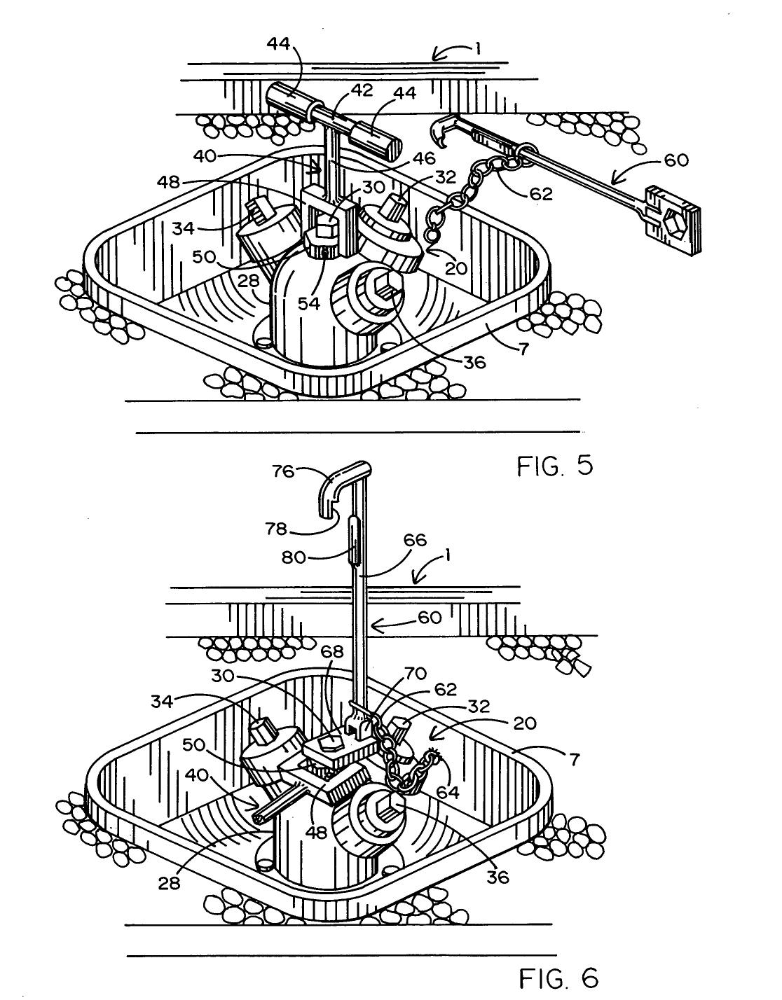

The second articulating tool 60 includes a J-shaped breaker bar 66 having a rectangular socket plate 68 pivotally connected to one end thereof. More particularly, the rectangular socket plate 68 is mated to a U-shaped yoke 70 by means of a pivot pin 72, whereby the breaker bar 66 and the yoke 70 are adapted to be rotated through an arc of 90 degrees relative to socket plate 68. A hexagonal opening 74 (best shown in FIG. 10) is formed through the socket plate 68. Opening 74 is sized to accommodate therewithin the hexagonal operating nut 30 of the main control valve body 28 of the flush mounted fire hydrant 20 (best shown in FIG. 6). In this case, the pivotal socket plate 68 at the first end of the J-shaped breaker bar 66 of articulating tool 60 functions as a socket wrench to apply a rotational force to operating nut 30 in a manner that will soon be described.

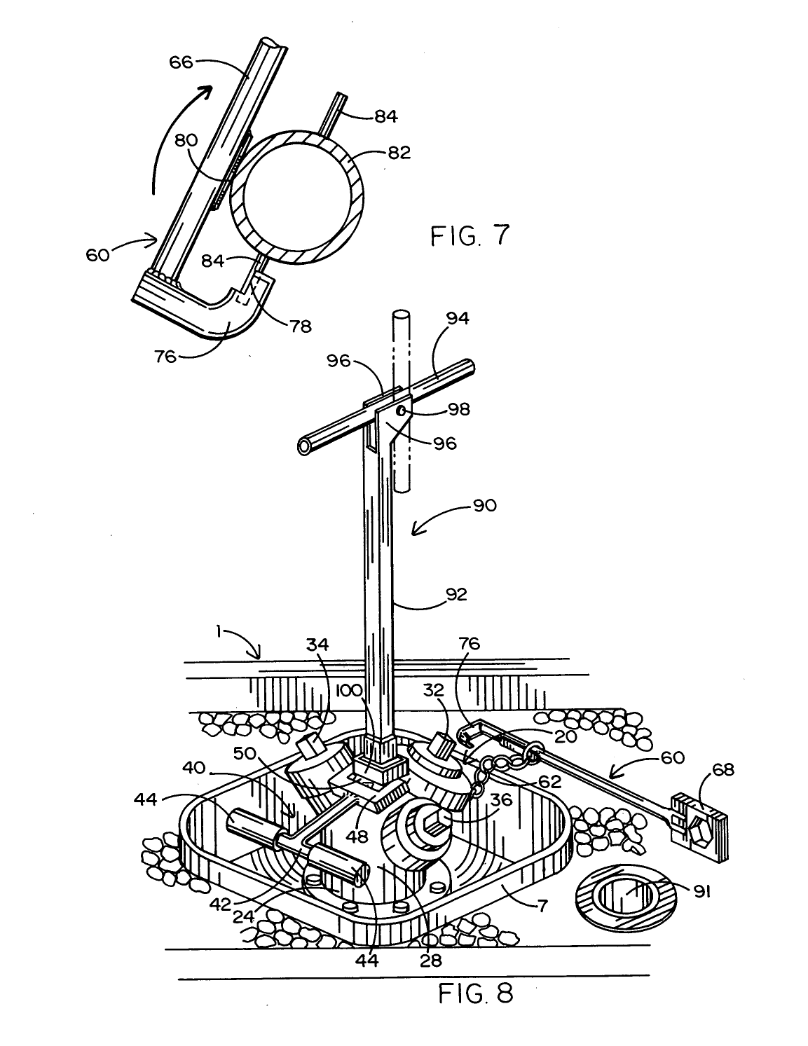

The other end of the J-shaped breaker bar 66 which lies opposite the socket plate 68 has a hook-like bend 76. The tip of the hook-like bend 76 is provided with a cut-out or recess 78 (also best shown in FIG. 6). As is best shown in FIG. 7, the hook-like bend 76 of the second articulating tool 60 is shaped and sized to be positioned relative to the cylindrical coupling connector 82 of the usual fire hose so as to enable the recess 78 to capture one of the outwardly projecting metal ears 84 of connector 82 so that a rotational force can be applied thereto, whereby to either tighten down or loosen the coupling connector 82 of the fire hose against one of the outlets 22, 24 or 26 of fire hydrant 20.

A hose flat (e.g., having a length of about 9 cm) is welded to the breaker bar 66 of articulating tool 60 adjacent the hook-like bend 76 so as to be positioned to receive the cylindrical fire hose coupling connector 82 thereagainst. Thus, it may be appreciated that the hose flat 80 on breaker bar 66 and the adjacent recess 78 in the hook-like bend 76 of breaker bar 66 will advantageously cooperate with one another to support the coupling connector 82 of the fire hose and capture a metal ear 84 thereof so as to facilitate a coupling or uncoupling of the fire hose at its outlet. In this case, the articulating tool 60 functions as a spanner wrench for applying a rotational force to the metal ear 84 of coupling connector 82 to rotate the coupling connector relative to an outlet of fire hydrant 20.

Referring once again to FIG. 6, the articulating tool 60 is shown coupled to the operating nut 30 of the main control valve body 28 of fire hydrant 20. To accomplish the foregoing, the socket plate 68 of articulating tool 60 is first rotated relative to the breaker bar 66 to which it is pivotally connected so as to project outwardly and in particular alignment therewith. The socket plate 68 is then laid over top of the main control valve body 28 so that the hexagonal operating nut 30 is received within the correspondingly shaped opening (designated 74 in FIG. 10) of the socket plate 68.

As shown in FIG. 6, the socket plate 68 of the second articulating tool 60 is positioned over the hex fitting 50 of the earlier disclosed first articulating tool 40 which is retained in surrounding engagement with the operating nut 30 of main control valve body 28. In this regard, it may be appreciated that the socket plate 68 of articulating tool 60 may be used as a redundant or back-up wrench to articulating tool 40 for rotating the operating nut 30 or any of the cover nuts 32, 34 and 36. In other words, the second articulating tool 60 is also capable of providing a rotational force to the operating nut 30 should the first articulating tool 40 break, fail or somehow become separated from the operating nut 30 in an emergency situation.

A third hand operated articulating tool 90 by which to generate a torque to rotate the hexagonal operating nut 30 of the main control valve body 28 or any of the cover nuts 32, 34 and 36 of the outlets 22, 24 and 26 of flush mounted fire hydrant 20 is now described while referring concurrently to FIGS. 8, 11 and 12 of the drawings. The third articulating tool 90 includes an elongated bar-like body 92 that is sized to be primarily carried on a fire truck or a crash vehicle used to fight airport fires rather than stored within the vault housing 7 like the previously disclosed first and second articulating tools 40 and 60. Nevertheless, and as is best shown in FIG. 8, a subsurface cylindrical storage tube 91 may be installed within the vault 1 within which to receive and retain the bar-like body 92 of tool 90.

Tool 90 also includes a handle 94 that is pivotally connected between a pair of flanges 96 that are affixed to one end of the tool 90. As is best shown in FIG. 12, the handle 94 is rotatable around a pivot pin 98 which extends through the pair of flanges 96 from a vertical position (shown in phantom lines) in parallel alignment with the bar-like body 92 so as to be suitable for transport on the fire truck to a horizontal position in perpendicular alignment with the body 94 so as to be suitable to receive a manually applied torque. In this regard, the bar-like body 92 of articulating tool 90 stands approximately 85 cm tall so that the pivotal handle 94 will be about waist high when the articulating tool 90 is used in the manner shown in FIG. 8. Moreover, so that the tool 90 will be capable of generating a sufficient rotational force in response to the manually applied torque, the handle has a length of approximately 45 cm.

Located at the other end of tool 90 opposite the pivotal handle 94 is a socket head 100. A hexagonal shaped opening 102 (best shown in FIG. 12) is formed in the socket head 100. Opening 102 is sized to accommodate therewithin the operating nut 30 of the main control valve body 28 when the articulating tool 90 is used in the manner shown in FIG. 8. In this case, the articulating tool 90 functions as a torque wrench so that a torque applied to the handle 94 is transferred as a corresponding rotational force against the operating nut 30 of the main control valve body 28 by way of socket head 100.

FIG. 8 shows the third articulating tool 90 with the pivotal handle 94 thereof rotated to the horizontal position and the socket head 100 positioned over top of the main control valve body 28 so that the hexagonal operating nut 30 is received within the hexagonal opening (designated 102 in FIG. 12) of socket head 100. Like the second tool 60 shown in FIG. 6, the third tool 90 of FIG. 8 can be disposed above the hex fitting 50 of the earlier described first tool 40. Thus, either one of the second or third tools 60 or 90 can serve as a back-up wrench to the first tool 40 for manipulating the operating nut 30 of main control valve body 28 or any of the cover nuts 32, 34 and 36 of outlets 22, 24 and 26. That is to say, like the earlier described second articulating tool 60, the third articulating tool 90 is also capable of providing a rotational force to the operating nut 30 should the first articulating tool 40 break, fail or somehow become separated from the operating nut 30 in an emergency situation.

It may now be appreciated that the three hand operated articulating tools 40, 60 and 90 described above can be used either individually or in combination with one another to provide reliable primary and back-up (i.e., redundant) means for rotating the operating nut 30 of main control valve body 28 and the cover nuts 32, 34 and 36 of the outlets 22, 24 and 26 of the flush mounted fire hydrant 20 so that a supply of water will be immediately available to fight an airport and/or aircraft fire in an emergency situation. Some of the articulating tools (e.g., 20 and 40) can be stored within the vault housing 7 of vault 1 while another tool (e.g., 90) is carried on a fire truck so that firefighters will have their choice of readily available, easy to use articulating hand tools to combat airport and aircraft fires.

1. For use with a flush mounted fire hydrant having at least one outlet to which a fire hose is to be connected, a control valve to be opened to cause the outlet to be pressurized with water to be supplied to the fire hose, and an operating nut to be rotated to open the control valve, the improvement of a tool to generate a rotational force to rotate the operating nut and thereby open the control valve, said tool comprising:
a handle located at one end of said tool to which a torque is manually applied;
a yoke connected to said handle and located at the opposite end of said tool; and
a fitting pivotally connected to said yoke and having an opening formed therein within which to receive and capture the operating nut,
said handle and said yoke being rotated upwardly relative to said fitting so that a torque applied to said handle is imparted to said fitting by way of said yoke for generating said rotational force to rotate the operating nut and open the control valve.

2. The tool recited in claim 1, wherein said handle and said yoke are rotated upwardly relative to said fitting through an arc of 90 degrees so that said handle is raised to a position above the operating nut of said flush mounted fire hydrant at which position the torque is manually applied to said handle.

3. The tool recited in claim 1, wherein the opening formed in said fitting is hexagonal.

4. The tool recited in claim 1, wherein said fitting is fixedly attached to the operating nut of said flush mounted fire hydrant so as to prevent a separation of said tool from the operating nut.

5. The tool recited in claim 4, further comprising at least one set screw extending through said fitting and into locking engagement with the operating nut, whereby said fitting is fixedly attached to the operating nut of said flush mounted fire hydrant to prevent the separation of said tool from the nut.

6. The tool recited in claim 1, further comprising a shaft extending between said handle and said yoke.

7. For use with a flush mounted fire hydrant having at least one outlet at which a fire hose is to be connected, a control valve to be opened to cause the outlet to be pressurized with water to be supplied to the fire hose, and an operating nut to be rotated to open the control valve, the improvement of a tool to generate a rotational force to rotate the operating nut and thereby open the control valve, said tool comprising:
a bend located at a first end of said tool;
a hose flat located adjacent said bend and adapted to receive thereagainst a cylindrical coupler of the fire hose to be connected to the at least one outlet of said flush mounted fire hydrant; and
a recess formed in said bend and positioned relative to said hose flat so as to be adapted to receive and capture an ear projecting radially outward from the cylindrical coupler of the fire hose such that a rotation of said bend causes a corresponding rotation of the ear of the cylindrical coupler to cause the cylindrical coupler of the fire hose to be connected to the at least one outlet.

8. The tool recited in claim 7, further comprising a yoke located at the opposite end of said tool and connected to said bend; and
a socket pivotally connected to said yoke and having an opening formed therein within which to receive and capture the operating nut of said flush mounted fire hydrant,
said yoke and said bend being rotated upwardly relative to said socket so that a torque manually applied to said bend is imparted to said socket by way of said yoke for generating said rotational force to rotate the operating nut and open the control valve of said flush mounted fire hydrant.

9. The tool recited in claim 8, wherein said yoke and said bend are rotated upwardly relative to said socket through an arc of 90 degrees so that said bend is raised to a position above the operating nut of said flush mounted fire hydrant at which position the torque is manually applied to said bend.

10. The tool recited in claim 7, wherein said bend at the first end of said tool is shaped like a hook.

11. The tool recited in claim 7, wherein the opening formed in said socket is hexagonal.

12. The tool recited in claim 7, further comprising a housing surrounding said flush mounted fire hydrant and a chain extending between said tool and said housing to prevent a separation of said tool from said housing.

13. The tool recited in claim 7, further comprising a J-shaped breaker bar having said bend at the first end of said tool and being connected to said yoke at the opposite end of said tool, said hose flat located on said breaker bar opposite said bend.

14. For use with a flush mounted fire hydrant having at least one outlet to which a fire hose is to be connected, a control valve to be opened to cause the outlet to be pressurized with water to be supplied to the fire hose, and an operating nut to be rotated to open the control valve, the improvement of a tool to generate a rotational force to rotate the operating nut and thereby open the control valve, said tool comprising:
an elongated body;
a socket head located at one end of said body and having an opening formed therein within which to receive and capture the operating nut; and
a handle pivotally connected to the opposite end of said body and rotatable relative to said body so that a torque manually applied to said handle is imparted to said socket head by way of said body for generating said rotational force to rotate the operating nut and open the control valve.

15. The tool recited in claim 14, wherein said handle is rotated through an arc of 90 degrees relative to said elongated body from a first, at rest position located in parallel alignment with said body to a second, active position located in perpendicular alignment with said body, said handle receiving said manually applied torque in said second, active position.
